(19) United States
(12) Patent Application Publication
(10) Pub. No.: US 2018/0295691 A1
(43) Pub. Date: Oct. 11, 2018

(54) ILLUMINATION LIGHT COMMUNICATION APPARATUS, ILLUMINATION EQUIPMENT, AND ILLUMINATION APPARATUS

(71) Applicant: Panasonic Intellectual Property Management Co., Ltd., Osaka (JP)

(72) Inventors: Teruhito TAKEDA, Hyogo (JP); Shigeaki YAMASAKI, Osaka (JP); Shojiro KIDO, Osaka (JP); Kazuo ITOH, Osaka (JP); Hiromichi GOTO, Osaka (JP); Hiroyuki NISHINO, Osaka (JP)

(21) Appl. No.: 15/942,934

(22) Filed: Apr. 2, 2018

(30) Foreign Application Priority Data
Apr. 6, 2017 (JP) 2017-075792

(51) Int. Cl. H05B 33/08; H04B 10/116; H04B 10/50

(52) U.S. Cl. CPC H05B 33/0845; H04B 10/502; H04B 10/116

(57) ABSTRACT

An illumination light communication apparatus to be connected to a light source that emits illumination light due to a current from a constant current generation device, and that modulates the illumination light includes: a switch connected in series to the light source; a signal generator circuit that generates a binary communication signal which controls ON and OFF states of the switch to modulate the illumination light; a current suppression circuit that is connected in series to the light source and the switch, and that suppresses the current flowing in the light source so that a current setting value corresponding to a reference value is not exceeded; and a controller that can change an ON duty ratio of the switch through the communication signal. The controller changes the ON duty ratio of the switch during a transition period in which a current flowing in the current suppression circuit changes.

### CROSS REFERENCE TO RELATED APPLICATION

The entire disclosure of Japanese Patent Application No. 2017-075792 filed on Apr. 6, 2017, including the specification, claims, drawings, and abstract, is incorporated herein by reference in its entirety.

### TECHNICAL FIELD

The present disclosure relates to an illumination light communication apparatus which executes visible light communication by modulating illumination light, illumination equipment, and an illumination apparatus.

### BACKGROUND

In the related art, in illumination equipment having a light emitting diode (LED) as a light source, visible light communication is proposed in which a signal is transmitted by modulating an intensity of the illumination light. In such an illumination light communication apparatus, because the signal is transmitted by modulating the illumination light itself, no special device such as an infrared communication apparatus is required. In addition, because power can be saved by using the light emitting diode as the illumination light source, use for a ubiquitous information system in an underground town or the like is being reviewed.

For example, JP 2015-19235 A discloses a visible light communication apparatus having a control circuit which modulates light intensity of illumination light which is output from a light source unit comprising a light emitting diode to superpose a communication signal. In this visible light communication apparatus, the control circuit divides a certain time period into a plurality of time slots, and a transmission process in which a communication signal is output in one of the time slots which is arbitrarily selected is periodically repeated. This reference discloses that, with such a configuration, even when lights from a plurality of illumination equipment overlap each other, the probability of a receiver terminal being able to receive the communication signal can be improved with a simple structure.

In an illumination apparatus which executes the visible light communication as described in JP 2015-19235 A, during transition from a state where the light source is lighted by a DC (direct current) current to a modulation mode in which the communication signal is superposed on the illumination light, due to an instantaneous change of the light intensity of the illumination light, there may be cases where a person sense flicker in their eyes.

An advantage of the present disclosure lies in the provision of an illumination light communication apparatus, an illumination equipment, and an illumination apparatus which can suppress occurrence of flickering during the transition of the lighting state of the light source to the modulation mode or the like.

### SUMMARY

According to one aspect of the present disclosure, there is provided an illumination light communication apparatus that is connected to a light source that emits illumination light due to a current from a constant current generation device flowing in the light source, and that modulates the illumination light of the light source, the illumination light communication apparatus comprising: a switch that is connected in series to the light source; a signal generator circuit that generates a binary communication signal which controls ON and OFF state of the switch in order to modulate the illumination light; a current suppression circuit that is connected in series to the light source and the switch, and that suppresses the current flowing in the light source so that a current setting value corresponding to a reference value is not exceeded; and a controller that can change an ON duty ratio of the switch through the communication signal. The controller gradually changes the ON duty ratio of the switch during a transition period in which a current flowing in the current suppression circuit changes.

According to another aspect of the present disclosure, there is provided an illumination equipment comprising the illumination light communication apparatus and the light source. According to yet another aspect of the present disclosure, there is provided an illumination apparatus comprising the illumination equipment and the constant current generation device.

### Advantageous Effects of Invention

According to the illumination light communication apparatus, the illumination equipment, and the illumination apparatus of the present disclosure, by gradually changing the ON duty ratio of the switch during a transition period such as during transition of the lighting state of the light source to the modulation mode, it becomes possible to suppress a feeling of flickering of the illumination light by people.

### BRIEF DESCRIPTION OF DRAWINGS

Embodiment(s) of the present disclosure will be described based on the following figures, wherein:

FIG. 1A is a diagram showing a structure of an illumination apparatus comprising an illumination light communication apparatus according to an embodiment of the present disclosure;

FIG. 1B is a diagram showing a structure of an illumination apparatus comprising an illumination light communication apparatus including a multiple-use control circuit in which a modulation operation of illumination light and a suppression operation of current flowing in a light source are both executed by a transistor;

FIG. 1C is a diagram showing a truth table showing a communication signal from the signal generator circuit of FIG. 1B and operation states of two valves and a transistor;

FIG. 2 is a diagram showing a structure of an illumination apparatus which does not have an illumination light communication apparatus;

FIG. 3 is a block diagram showing an example structure of the control circuit and the signal generator circuit shown in FIG. 1A;

FIG. 4 is a flowchart showing an example process of the control circuit shown in FIG. 1A;

FIG. 5 is an explanatory diagram of a shift register in a control circuit;

FIG. 6 is a flowchart showing an example correction of step S20 of FIG. 4;

FIG. 7 is a diagram for explaining a modulation method of a communication signal;

FIG. 8 is a diagram showing cases (a)-(d) of a communication signal;

FIG. 9 is an explanatory diagram showing a waveform of an LED current which is intermittent;

FIG. 10 is a diagram showing a current setting value according to an ON duty ratio;

FIG. 11A is a diagram showing gradual change of an ON duty ratio in a transition period which is set between a DC lighting mode and a modulation mode;

FIG. 11B is a diagram showing gradual change of an ON duty ratio in a transition period which is set between a first modulation mode and a second modulation mode;

FIG. 12 is a diagram showing gradual change of an ON duty ratio in a transition period which is set at a startup of an illumination apparatus;

FIG. 13 is a diagram showing gradual change of an ON duty ratio in a transition period which is set at a time of stopping of driving of an illumination apparatus;

FIG. 14A is a diagram showing gradual change of an ON duty ratio in a transition period which is set between a first light adjustment state and a second light adjustment state having different light intensities of the light source; and

FIG. 14B is a diagram showing a case where an ON duty ratio of the modulation mode is the same between the first light adjustment state and the second light adjustment state in FIG. 14A.

### DESCRIPTION OF EMBODIMENTS

An embodiment of the present disclosure will now be described in detail with reference to the accompanying diagrams. In this description, specific shapes, materials, numerical values, directions, or the like are exemplary merely for facilitating understanding of the present disclosure, and may be suitably changed according to the usage, objective, specification, or the like. In the following description, a description of “approximate” is used to mean, for example, cases where the values are completely equal, and also cases where the values can be considered to be substantially the same. Further, in the following, when a plurality of embodiments and alternative configurations are included, characteristic portions thereof may be suitably combined, and such a combination is conceived of from the start.

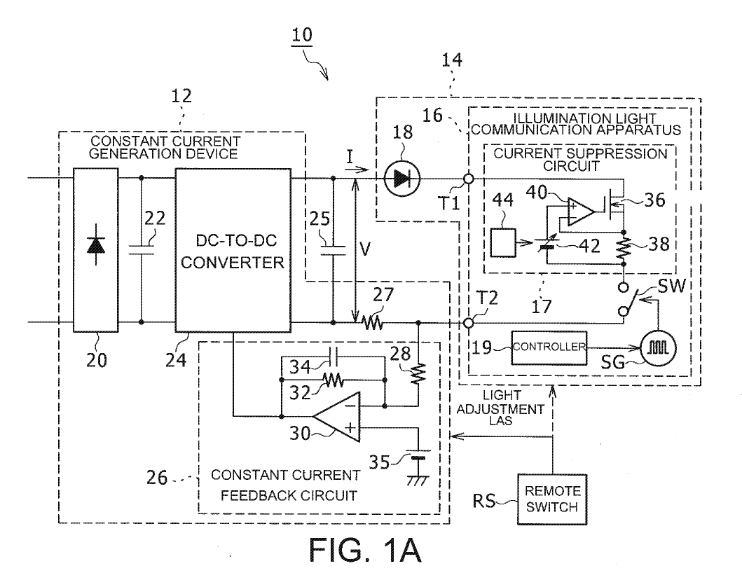

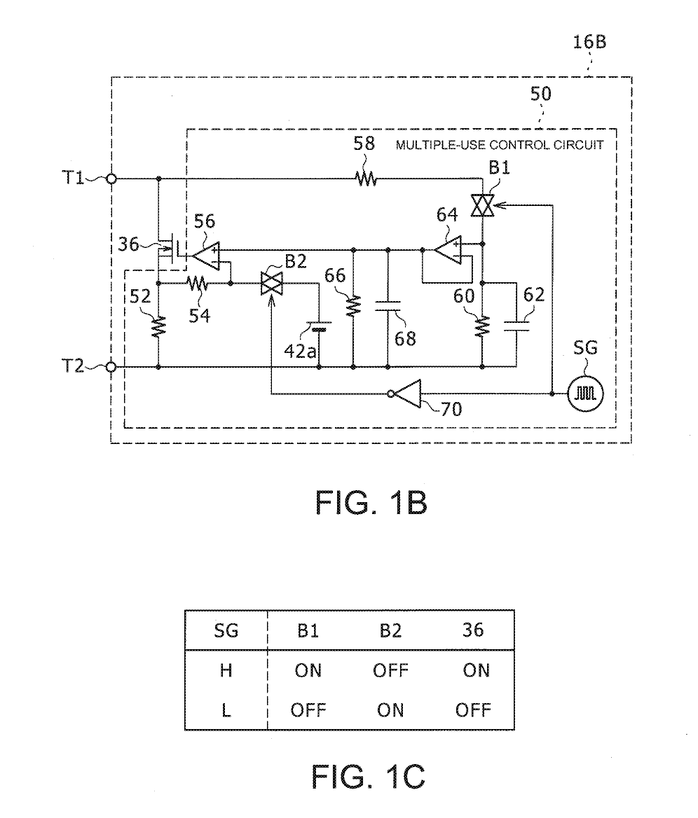

FIG. 1A is a diagram showing a structure of an illumination apparatus 10 having an illumination light communication apparatus 16 according to an embodiment of the present disclosure. The illumination apparatus 10 comprises a constant current generation device 12 and an illumination equipment 14. The illumination equipment 14 comprises the illumination light communication apparatus 16 and a light source 18.

The constant current generation device 12 has a function to make an output current a constant current, and comprises a rectifier bridge 20, a capacitor 22, a DC-to-DC converter 24, and a constant current feedback circuit 26. The constant current feedback circuit 26 comprises an input resistor 28, an amplifier 30, a resistor 32, a capacitor 34, and a reference voltage source 35.

The constant current generation device 12 full-wave rectifies a commercial power supply (for example, AC 100V) using the rectifier bridge 20, smooths the resulting voltage with the capacitor 22, and converts the voltage into a desired DC voltage by a DC-to-DC converter 24. A smoothing capacitor 25 is connected between output terminals of the DC-to-DC converter 24. In parallel with the smoothing capacitor 25, a series connection circuit of the light source 18 and the illumination light communication apparatus 16 is connected. The illumination light communication apparatus 16 comprises a current suppression circuit 17, an intermittent switch SW, a signal generator circuit SG, and a controller 19.

The constant current generation device 12 has a function to directly or indirectly detect a current flowing in the light source 18, and to set the current value to a constant. This function is achieved by a detection resistor 27 for directly detecting the current of the light source 18 and the constant current feedback circuit 26. In the constant current feedback circuit 26, the reference voltage source 35 is connected to a positive input terminal of the amplifier 30, and the input resistor 28 is connected to a negative input terminal of the amplifier 30. In addition, in the constant current feedback circuit 26, a gain adjusting resistor 32 and a phase compensating capacitor 34 are connected in parallel, between an output terminal of the amplifier 30 and the negative input terminal of the amplifier 30.

The constant current feedback circuit 26 compares, using the amplifier 30, a voltage drop of the detection resistor 27 and the voltage of the reference voltage source 35, amplifies the difference thereof, and feeds back to the controller of the DC-to-DC converter 24. In other words, a negative feedback control is applied to the DC-to-DC converter 24 so that the voltage drop of the detection resistor 27 and the reference voltage match each other. In addition, a gain is set by a voltage division ratio of the resistor 32 connected between an inverted input terminal and the output terminal of the amplifier 30 and the input resistor 28, and the capacitor 34 provided in parallel to the resistor 32 functions as an integration element for phase compensation.

The smoothing capacitor 25 is connected between outputs of the constant current generation device 12, and smooths the output of the constant current generation device 12.

The light source 18 includes a plurality of light emitting diodes which are connected in series, between outputs of the constant current generation device 12, and an output of the constant current generation device 12 is supplied thereto. The light emitting element forming the light source 18 is not limited to a light emitting diode, and may alternatively be other light emitting elements (for example, an organic electroluminescence element, a semiconductor laser element, or the like).

The intermittent switch SW is attached in series to the light source 18, and interrupts the current supplied from the constant current generation device 12 to the light source 18. The intermittent switch SW corresponds to a switch in the present disclosure.

The signal generator circuit SG generates a binary communication signal for controlling ON and OFF state of the intermittent switch SW in order to modulate the illumination light. The communication signal is input to a control terminal of the intermittent switch SW, and switches the intermittent switch SW ON and OFF. An ON duty ratio of a communication signal generated by the intermittent switch SW is configured to be changeable by receiving a command from the controller 19. The signal generator circuit SG may repeatedly generate a communication signal showing a unique ID such as, for example, product information, stored in the controller 19, or may generate a communication signal according to a transmission signal which is input from an external device.

Next, an example structure of the current suppression circuit 17 will be described.

The current suppression circuit 17 is attached in series to the light source 18 and the intermittent switch SW, and suppresses a size of the current flowing in the light source 18. For example, the current suppression circuit 17 is connected in series to the light source 18 and the intermittent switch SW, and may suppress the current flowing in the light source 18 according to a reference value so that a current setting value corresponding to the reference value is not exceeded. In this manner, an overshoot generated in the current flowing in the light source 18 can be reduced at the instant when the intermittent switch SW is switched from OFF to ON, and thus, a reception error at the receiver device can be reduced.

The current suppression circuit 17 comprises a transistor 36 which is a MOSFET, a resistor 38 connected to a source, an amplifier 40, a reference source 42, and a control circuit 44.

The reference source 42 outputs a reference value to a positive input terminal of the amplifier 40. The reference value defines an upper limit (current setting value) of the current flowing in the light source 18. For example, the reference value is proportional to the current setting value. Alternatively, the reference source 42 may output a variable reference value according to an arrangement pattern (for example, a bit pattern) of the communication signal generated by the signal generator circuit SG.

The transistor 36 is connected in series to the light source 18 and the intermittent switch SW, and suppresses the current flowing in the light source 18 based on the reference value.

The resistor 38 is a source resistor for detecting the size of the current flowing in the light source 18. A source-side terminal of the resistor 38 is connected to a negative input terminal of the amplifier 40.

In the amplifier 40, the reference source 42 is connected to the positive input terminal, and a source of the transistor 36 is connected to the negative input terminal. The amplifier 40 amplifies a difference between the reference value and the current value detected by the resistor 38, and outputs the amplified signal to a gate of the transistor 36.

The control circuit 44 applies a control to change the reference value of the reference source 42 according to the arrangement pattern of the communication signal, in order to output a variable reference value from the reference source 42. For example, the control circuit 44 calculates a partial ON duty ratio of the communication signal, sets the reference value to a first value when the calculated partial ON duty ratio is a first ratio, and sets the reference value to a second value smaller than the first value when the partial ON duty ratio is a second ratio larger than the first ratio. In this process, the control circuit 44 may change the reference value so that the reference value is inversely proportional to the partial ON duty ratio of the communication signal. The “partial ON duty ratio” is, for example, a ratio of the ON period with respect to a period in which the most recent OFF period and the ON period immediately before the OFF period are combined.

Alternatively, the “partial ON duty ratio” may be substituted by a running average value of most recent n bits of the communication signal. With such a configuration, when the size of the overshoot generated in the current flowing in the light source 18 depends on the partial ON duty ratio, the overshoot can be more appropriately suppressed.

As shown in FIG. 1A, the illumination apparatus 10 may comprise a remote switch RS. The remote switch RS transmits a light adjustment signal LAS which adjusts the light intensity of the light source 18 according to a user operation or the like. The light adjustment signal LAS is transmitted to the constant current generation device 12 by, for example, wireless communication such as infrared communication, wireless LAN, Wi-Fi, or the like. The constant current generation device 12 can change the current value to be output, according to the light adjustment signal. In addition, the light adjustment signal generated by the remote switch RS is also transmitted to the illumination light communication apparatus 16. With such a configuration, the control circuit 44 of the current suppression circuit 17 can set the reference value according to the light adjustment signal, and the controller 19 of the illumination light communication apparatus 16 can execute the control of the ON duty ratio of the intermittent switch SW to be described later.

Alternatively, the light adjustment signal LAS generated by the remote switch RS may be transmitted only to the illumination light communication apparatus 16. With such a configuration, the control circuit 44 of the current suppression circuit 17 can set the reference value according to the light adjustment signal LAS. In addition, with the controller 19 of the illumination light communication apparatus 16 executing the control of the ON duty ratio of the intermittent switch SW to be described later, the controller 19 can execute not only the visible light communication, but also the light adjustment control. Although the power loss at the current suppression circuit 17 is increased, by using the constant current generation device and the LED light source equipped in the existing illumination equipment which does not have the light communication function and the light adjustment function and adding the illumination light communication apparatus 16 later, it becomes possible to add the light communication function and the light adjustment function to the existing equipment.

Next, with reference to FIG. 1B, an illumination light communication apparatus 16B according to an alternative configuration will be described. FIG. 1B is a diagram showing an example structure of the illumination light communication apparatus 16B including a multiple-use control circuit 50 which makes the transistor function both for the modulation operation of the illumination light and the suppression operation of the current flowing in the light source. In the example structure, the transistor 36 also has the function of the intermittent switch SW.

The illumination light communication apparatus 16B of FIG. 1B comprises the transistor 36 and the multiple-use control circuit 50. The multiple-use control circuit 50 comprises a reference source 42a, the signal generator circuit SG, a valve B1, a valve B2, a resistor 52, a resistor 54, an amplifier 56, a resistor 58, a resistor 60, a capacitor 62, an amplifier 64, a resistor 66, a capacitor 68, and an inverter 70.

In the multiple-use circuit 50, a circuit portion including the signal generator SG, the valve B1, the valve B2, and the inverter 70 functions as a modulation control circuit which causes the transistor 36 to execute the modulation operation.

The signal generator circuit SG has already been described, and will not be described again.

The valve B1 may be, for example, a switching element such as a switching transistor, a thyristor, or the like, and is set in an open state or a closed state; that is, a non-conduction state or a conduction state, according to the control signal which is input to a control terminal. The communication signal from the signal generator circuit SG is input to a control terminal of the valve B1.

The valve B2 may be the same element as the valve B1. A signal that is the communication signal from the signal generator circuit SG inverted through the inverter 70 is input to a control terminal of the valve B2. The valve B2 is connected to a negative input terminal that is at a level of the size of the current flowing in the light source, of two input terminals of the amplifier 56, and wiring that is at a level of substantially the reference value (that is, positive-side wiring of the reference source 42a).

Operation states of the valve B1, the valve B2, and the transistor 36 will now be described with reference to FIG. 1C. FIG. 1C is a diagram showing a truth table representing the communication signal from the signal generator circuit SG of FIG. 1B, and the operation states of the valves B1 and B2 and the transistor 36. “SG” shows a logical value (high level or low level) of the communication signal, “B1” shows the state (ON or OFF) of the valve B1, “B2” shows the state (ON or OFF) of the valve B2, and “36” shows the state (ON or OFF) of the transistor 36. When the communication signal is L (low level), the valve B1, the valve B2, and the transistor 36 are respectively in the OFF, ON, and OFF states, no current flows in the light source 18, and the device is not lighted. Specifically, the valve B2 is set in the conduction state when the communication signal indicates light extinguishment, so that the level of the negative input terminal corresponding to the size of the current, of the two input terminals, is substantially set to the level of the reference value. With such a configuration, the output signal of the amplifier 56 is set to the low level, and the transistor 36 is switched OFF.

When the communication signal is H (high level), the valve B1, the valve B2, and the transistor 36 are respectively in the ON, OFF, and ON states, a current flows in the light source, and the device is lighted.

With such a configuration, the illumination light is modulated by the ON and OFF state of the transistor 36 according to the binary communication signal.

A circuit portion of the multiple-use control circuit 50 other than the signal generator circuit SG, the valve B1, the valve B2, and the inverter 70 functions as a current suppression circuit for suppressing the current flowing in the transistor 36 (that is, the light source 18).

The resistor 52 is a resistor for detecting the size of the current flowing in the transistor 36, that is, the current flowing in the light source 18.

The resistor 54 is a resistor for limiting the current flowing in grounding wiring from the reference source 42a through the resistor 54 and the resistor 52 when the valve B2 is in the ON state.

The resistor 58 and the resistor 60 form a circuit which functions as a variable reference source. Specifically, the resistor 58 and the resistor 60 detect the size of the voltage applied to the multiple-use control circuit 50 when the valve B1 is in the ON state. A voltage at a connection point between the valve B1 and the resistor 60 shows the size of the voltage applied to the multiple-use control circuit 50, and is input to the positive input terminal of the amplifier 56 as a reference value through the amplifier 64 (which functions as a buffer in this process). The voltage applied to the multiple-use control circuit 50 changes according to the ON duty ratio of the communication signal from the signal generator circuit SG. In FIG. 1B, the voltage applied to the multiple-use control circuit 50 is input to the positive input terminal of the amplifier 56 as the variable reference value. With the variable reference value, the current setting value which shows the upper limit of the current flowing in the transistor 36 can be set to an appropriate value according to the reference value and the ON duty ratio.

The reference source 42a generates a constant voltage of greater than or equal to the reference value.

The resistor 60 and the capacitor 62 function as a filter, and the amplifier 64 functions as a buffer for impedance matching. The resistor 66 and the capacitor 68 functions as a filter for cutting noise.

As described, in the multiple-use control circuit 50 of FIG. 1B, the valve B2 (for example, a switching transistor) sets a level at the negative input terminal to a level which is substantially the level of the reference value when the communication signal instructs light extinguishment (when SG is L), to set the transistor 36 to the OFF state. With this process, the multiple-use control circuit 50 can make the transistor 36 execute the modulation operation, and, at the same time, can suppress the current flowing in the light source 18 to a value lower than or equal to the current setting value.

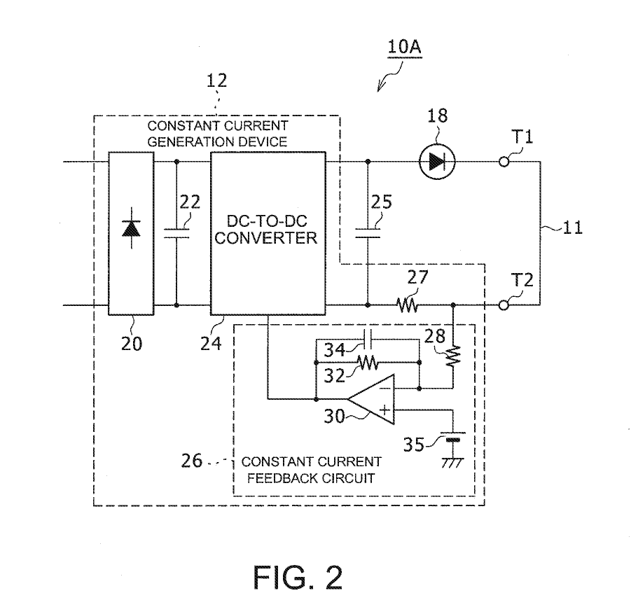

Next, a structure of a detachable illumination light communication apparatus 16 will be described. FIG. 2 is a circuit diagram showing a structure of an illumination apparatus 10A to which the illumination light communication apparatus 16 is not added. That is, FIG. 2 shows a structure in which the illumination light communication apparatus 16 is removed from the illumination apparatus 10 of FIG. 1A, and short-circuiting wiring 11 is added. FIG. 1A shows the illumination apparatus 10 having the visible light communication function, and FIG. 2 shows the illumination apparatus 10A which does not have the visible light communication function.

The illumination light communication apparatus 16 or the short-circuiting wiring 11 is connected to terminals T1 and T2 of FIGS. 1A and 2. The terminals T1 and T2 may be a terminal base or a connector. Alternatively, locations, of the wiring in the existing illumination apparatus, where the wiring material corresponding to the short-circuiting wiring 11 of FIG. 2 is cut, may be set as the terminals T1 and T2.

According to the structures shown in FIGS. 1A and 2, by using the constant current generation device and the LED light source equipped in the existing illumination equipment which does not have the light communication function, and adding the illumination light communication apparatus 16 later, it becomes possible to add the light communication function. The possibility of addition at a later time in this manner is similarly true for the illumination light communication apparatus 16B shown in FIG. 1B.

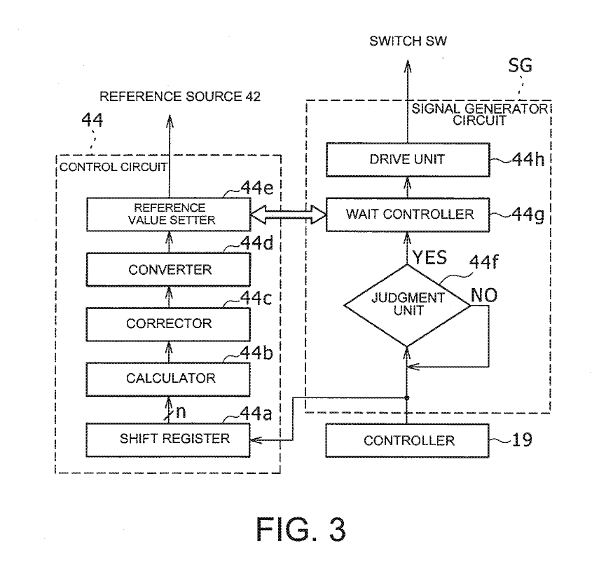

Next, with reference to FIGS. 3˜6, the structure of the control circuit 44 which executes control to change the reference value of the reference source 42 according to a signal arrangement of the communication signal will be described in more detail. Specifically, the control circuit 44 has a shift register which holds n-bit data (wherein n is an integer greater than or equal to 2) of the communication signal while shifting the data. An example configuration will now be described in which the partial ON duty ratio of the communication signal is calculated based on the n-bit data, and the reference value is determined according to the calculated partial ON duty ratio.

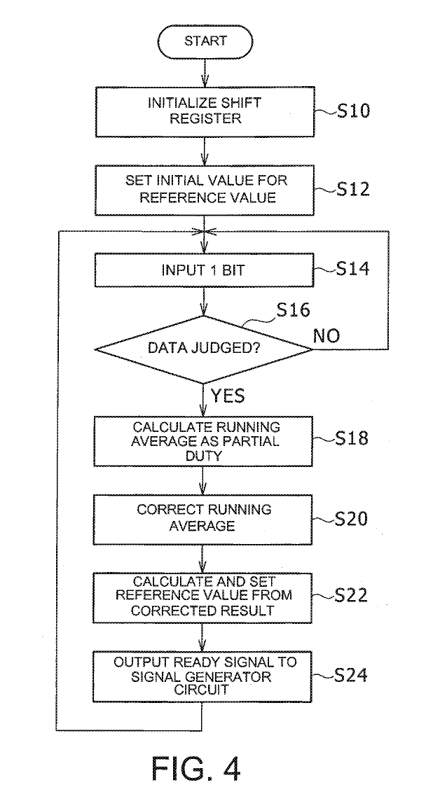

FIG. 3 is a block diagram showing example structures of the control circuit 44 and the signal generator circuit SG in FIG. 1. In FIG. 4, the control circuit 44 comprises a shift register 44a, a calculator 44b, a corrector 44c, a converter 44d, and a reference value setter 44e.

The shift register 44a holds the n-bit data (wherein n is an integer greater than or equal to 2) of the communication signal generated by the signal generator circuit SG while shifting the data.

The calculator 44b calculates the partial ON duty ratio of the communication signal based on the n-bit data held in the shift register 44a. The partial ON duty ratio is, for example, (i) a ratio of the ON period with respect to a period in which the most recent OFF period (period in which a bit of 0 continues), and the ON period (period in which a bit of 1 continues) which is immediately before the OFF period, are combined. Alternatively, the partial ON duty ratio may be (ii) substituted by a running average value of the most recent n bits of the communication signal, or a running average value of a predetermined number of bits in the n bits.

When the running average value is to be calculated as the partial ON duty ratio, the calculator 44b may calculate, a simple arithmetic mean for the n bits of the shift register 44a.

The corrector 44c applies a correction to the partial ON duty ratio calculated by the calculator 44b. When the calculation methods differ as in (i) and (ii) described above, the calculated results would also differ, and thus, the result is corrected by the corrector 44c.

The converter 44d converts the corrected partial ON duty ratio to a corresponding suitable reference value. In other words, the converter 44d determines the suitable reference value according to the corrected partial ON duty ratio.

The reference value setter 44e sets the determined reference value to the reference source 42. In other words, the reference value setter 44e controls the reference source 42 so that the reference source 42 outputs the determined reference value.

Next, an example structure of the signal generator circuit SG will be described.

In FIG. 3, the signal generator circuit SG comprises a judgment unit 44f, a wait controller 44g, and a drive unit 44h.

The communication signal from the controller 19 is input to the judgment unit 44f. The communication signal may repeatedly include the ID of the illumination apparatus 10, or include information from the outside (for example, product information or the like).

The judgment unit 44f judges whether or not the most recent bit which is output from the controller 19 is “1.” When a bit immediately before the most recent bit is 0, a rising edge is generated in a current waveform of the light source 18 by the most recent bit which is output from the controller 19. When the bit immediately before the most recent bit is 1, the conduction state of the light source 18 is continued for a period of the most recent bit which is output from the controller 19.

When the judgment unit 44f judges that the most recent bit is “1”, the wait controller 44g causes the driving of the intermittent switch SW by the most recent bit, that is, the operation to output the most recent bit to the gate of the intermittent switch SW, to wait until a ready signal is received from the control circuit 44. The waiting is for allowing completion of the setting of the reference value according to the partial ON duty ratio immediately before the rising edge in the current suppression circuit 17, before the rising edge is generated in the current waveform of the light source 18.

The drive unit 44h outputs the above-described most recent bit of “1” to the gate of the intermittent switch SW at a timing when the ready signal is received from the control circuit 44.

In place of judging whether or not the most recent bit which is output from the controller 19 is “1,” the judgment unit 44f may judge whether or not the most recent two bits which are output from the controller 19 are “01”, that is, whether or not the most recent bit is 1 and the bit immediately before is 0. With such a configuration, the judgment unit 44f judges whether or not the rising edge is generated in the current waveform of the light source 18 by the most recent bits which are output from the controller 19.

Next, an example operation of the control circuit 44 will be described in more detail.

FIG. 4 is a flowchart showing an example process of the control circuit 44 in FIG. 1A. In FIG. 4, at the start of the visible light communication at the illumination apparatus 10 (for example, at the startup of the illumination apparatus 10), the control circuit 44 first initializes (for example, resets) the shift register 44a (step S10), and sets the reference value of the reference source 42 to an initial value (step S12). The initial value may be, for example, a reference value corresponding to an average ON duty ratio of 75% of the communication signal.

When one bit of the communication signal which is serially generated by the controller 19 is input to the shift register 44a (step S14), the control circuit 44 judges whether or not the input one bit is 1 (step S16).

When it is judged that the input one bit is 1, the control circuit 44 calculates the average value of the n-bit data held by the shift register 44a as the partial ON duty ratio (step S18). The average value is a running average value determined while shifting the n bits of the communication signal which is serial data for every loop process (steps S14 S24) of FIG. 4. Further, the control circuit 44 corrects the running average value (step S20), determines the reference value from the corrected result and sets the reference value in the reference source 42 (step S22), and outputs the ready signal to the signal generator circuit SG (step S24). With the output of the ready signal, the one bit which is input in step S14 is output to the gate of the intermittent switch SW. In step S22, the calculation of the current setting value of the current suppression circuit 17 and the reference value from the corrected running average value can be executed, for example, by referring to a numerical value table which is stored in advance. The numerical value table may be, for example, a table correlating the corrected running average value and the reference value.

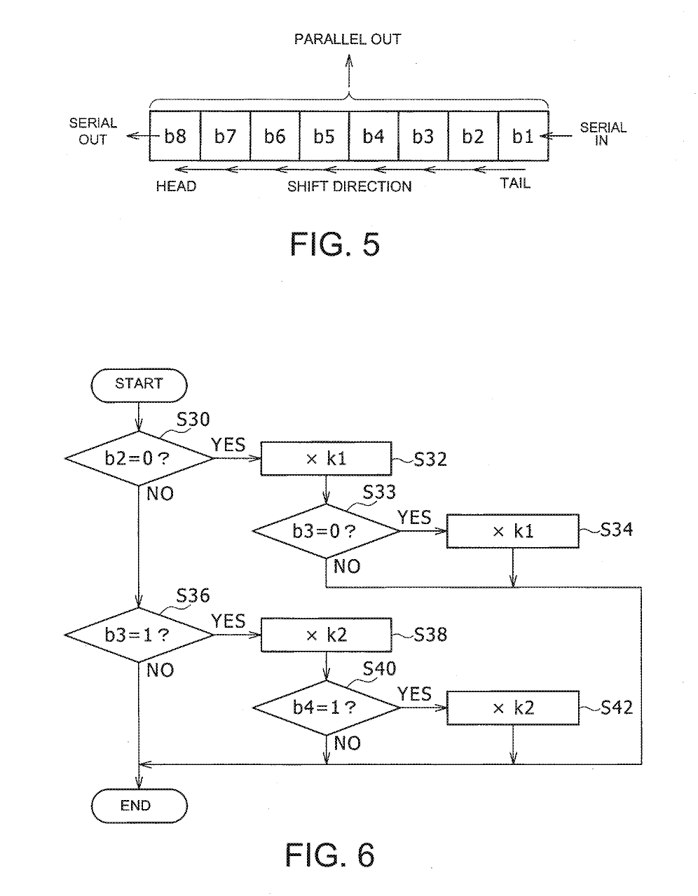

Next, with reference to FIG. 5, an example structure of the shift register 44a will be described. FIG. 5 is an explanatory diagram showing an example structure of the shift register 44a in the control circuit 44. In FIG. 5, a shift register 44a of 8 bits is exemplified. The shift register 44a comprises a serial-in terminal for inputting 1-bit data, a parallel-out terminal for outputting 8-bit data, and a serial-out terminal for outputting 1-bit data. In the held 8-bit data, the bits are called, from the side of the serial-in terminal, a bit b1, a bit b2, . . . and a bit b8. The bit b1 is the most recent bit which is output from the controller 19. At the timing when the most recent bit is input to the bit b1 from the serial-in terminal, the bit b2 is input to the gate of the intermittent switch SW. The bit b1 is output to the gate of the intermittent switch SW at a timing when the ready signal of step S24 of FIG. 4 is output.

Next, with reference to FIG. 6, a specific example of the correction in step S20 of FIG. 4 will be described.

FIG. 6 is a flowchart showing an example correction of step S20 of FIG. 4. When the running average value is calculated in step S18, the most recent bit b1 of the shift register 44a is 1, as judged in step S16. In FIG. 6, if the bit b2 immediately before the most recent bit b1 is 0 (YES in step S30), the control circuit 44 multiplies the running average value by a coefficient k1 (step S32), and further, if the bit b3 immediately before the bit b2 is 0 (YES in step S33), the control circuit 44 again multiplies by the coefficient k1 (step S34). In other words, when the first bit b1 from the tail of the shift register 44a is 1, and the bits after the second bit b2 are 0 and consecutive for one bit or more, the control unit 44 multiplies the running average value by the coefficient k1 which is smaller than 1 by the same number of times as the number of consecutive bits of 0. Here, the coefficient k1 may be, for example, 0.9.

On the other hand, when step S30 results in NO, if the bit b3 is 1 (YES in step S36), the control circuit 44 multiplies the running average value by a coefficient k2 (step S38), and further, if the bit b4 is 1 (YES in step S40), the control circuit 44 again multiplies by k2 (step S42). In other words, when the first bit b1 from the tail of the shift register 44a is 1 and the bits after the second bit b2 or the third bit b3 are 1 and consecutive for one bit or more, the control circuit 44 multiplies the running average value by the coefficient k2 which is greater than 1 by the same number of times as the number of consecutive bits of 1 after the bit b2 or b3. Here, the coefficient k2 may be, for example, 1.03.

With such a correction, the running average value in all data arrangements that can be conceived of may be set in a range of about 0.5˜0.9. The above-described correction method is merely exemplary, and selection according to the necessary dynamic range is required. In particular, the coefficient to be multiplied would vary depending on the data transmission method which is used and the power supply circuit conditions, or the like, and thus, is suitably set according to the actual conditions.

With such a structure, the generation of the overshoot in the current flowing in the light source 18 can be more appropriately suppressed.

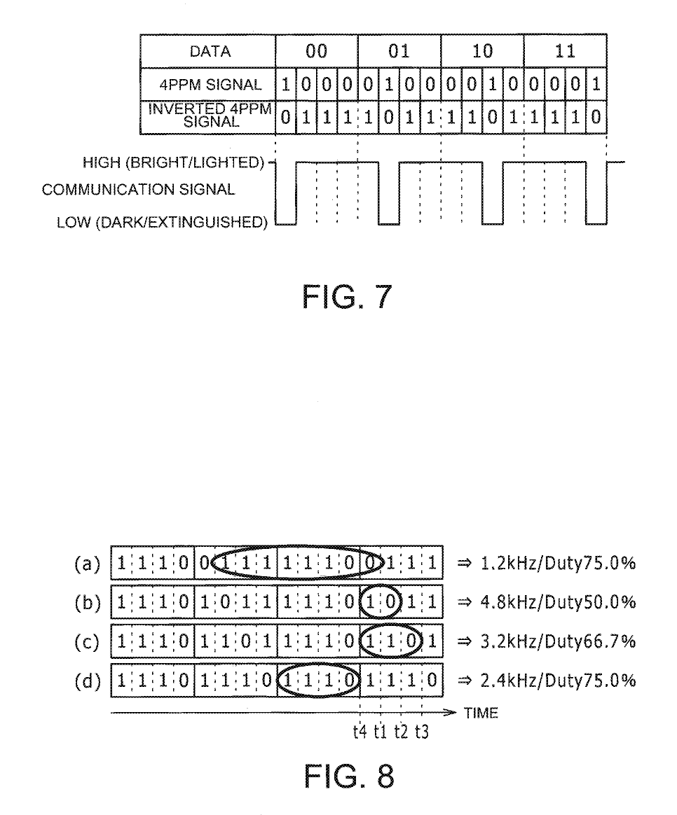

FIG. 7 is an explanatory diagram showing a modulation method of the communication signal. FIG. 7 shows a case of a modulation signal form used in the illumination light communication apparatus. FIG. 7 conforms with the I-4 PPM (I-4 Pulse Position Modulation) transmission standards defined in JEITA-CP1223. For example, a 4 PPM signal of 2-bit data “00” is modulated to “1000” in a 1-symbol period made of 4 slots. In other words, a pulse appears in 1 slot among the 4 slots. In the visible light communication, in order to secure a lighting time by lighting 3 slots among the 4 slots, in many cases, an inverted 4 PPM signal is used. The communication signal of FIG. 7 is a signal modulated to the inverted 4 PPM signal. In this case, a high level of the communication signal switches the intermittent switch SW ON, to light the light source 18. A low level of the communication signal switches the intermittent switch SW OFF, and extinguishes the light source 18. For example, 1 slot is 104.167 usec (=1/9.6 kHz), and one symbol (here, one symbol is two bits) is formed by 4 slots (416 usec). The I-4 PPM signal is binary with logical values of 0 and 1, and a data arrangement is provided in which the logical value of 1 appears in 1 slot among the 4 slots. The communication signal generated by the signal generator circuit SG is the inverted 4 PPM signal in which the logical value is inverted. The inverted 4 PPM signal modulates the data depending on where in the 4 slots a negative pulse appears, and, in viewing the 4 slots of 1 symbol, the ON duty ratio is 75%. However, if the breakpoint of the symbols is ignored, there exist various signal arrangement patterns, and consequently, various partial ON duty ratios. FIG. 8 shows example cases of such duty ratios.

FIG. 8 shows cases (a)˜(d) of the communication signal. In the data of 4 symbols of FIG. 8, a circle symbol (⊚) is attached to the OFF period and the ON period immediately before a rise from the low level to the high level of the communication signal. Based on the partial data surrounded by the circle symbol, the partial ON duty ratio may be defined, for example, as a ratio of the ON period with respect to a period in which a most recent FF period and the ON period immediately before the OFF period are combined (one cycle which is most recent). In the case (a) of FIG. 8, the frequency of the most recent one cycle is 1.2 kHz, and the partial ON duty ratio is 75%. In the case (b), the frequency is 4.8 kHz and the partial ON duty ratio is 50%, in the case (c), the frequency is 3.2 kHz and the partial ON duty ratio is 66.7%, and in the case (d), the frequency is 2.4 kHz and the partial ON duty ratio is 75%. In this manner, by changing the position and the number of the logical value of 1 in the 4-PPM signal forming the communication signal, it is possible to change the ON duty ratio of the intermittent switch SW.

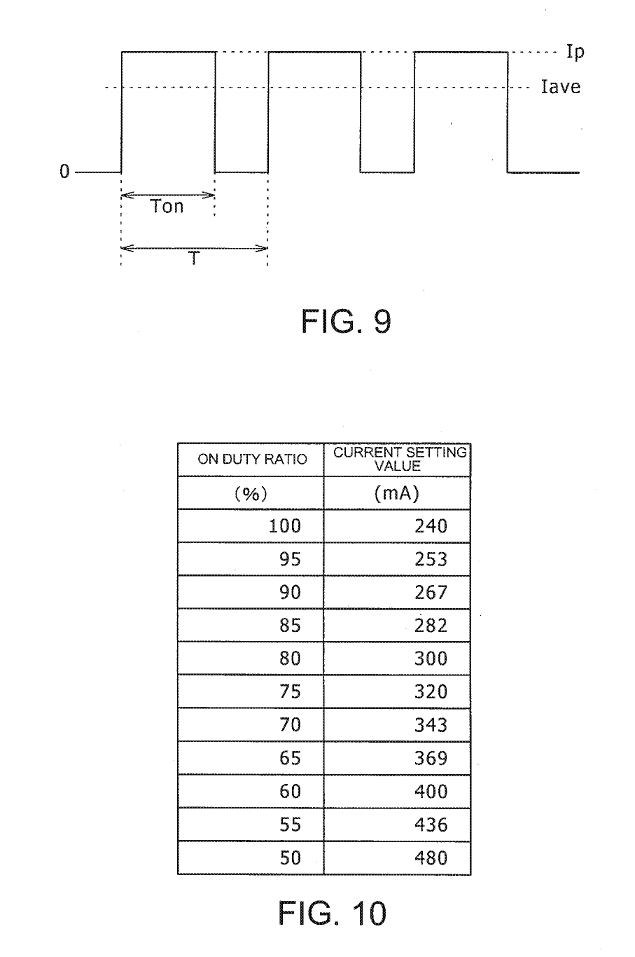

Next, an optimum current setting value of the current suppression circuit 17 based on the partial ON duty ratio of the communication signal from the signal generator circuit SG will be described. As already described, the constant current generation device 12 presumed for the illumination apparatus 10 in the present embodiment has a constant current feedback function. A typical case is the constant current feedback circuit 26 which uses an amplifier, as shown in FIG. 1A. Normally, a phase compensation circuit is added in order to secure stability of the feedback system. For the phase compensation circuit, a compensation circuit including an integration element for adjusting the gain and the phase in an open loop transfer function is used. Such control is known as a PI control or a PID control. Such a phase compensation circuit may alternatively be considered as a means which controls an average value of the output to a constant. Based on such an understanding, FIG. 9 is an explanatory diagram showing an ideal waveform of an LED current which is intermittent. In the intermittent waveform of the LED current shown in FIG. 9, an average Iave of the waveform can be represented by the following formula (1).

Iave=Ip×d/100 (1)

Here, Ip represents a peak value of the LED current, and d is the ON duty ratio, represented by 100×Ton/T (%).

The average value Iave is controlled to become identical to the average current when the waveform is not interrupted, by the constant current feedback function, and is controlled to be a constant value even when the ON duty ratio is changed. Specifically, when the ON duty ratio is reduced, the peak value Ip is increased so that Iave is a constant. When the peak value Ip is set as the current setting value of the current suppression circuit 17, the LED current waveform becomes a rectangular waveform, and consequently, the overshoot can be removed and the loss in the current suppression circuit 17 can be suppressed. Thus, a so-called optimum current setting value can be obtained (refer to formula (2)).

Optimum current setting value=Iave/d/100 (2)

Here, Iave is the LED average current when the intermitting is not applied.

FIG. 10 shows calculation of the optimum current setting value for each partial ON duty ratio using formula (2) under a condition that the LED average current when no interruption is applied is 240 mA. As shown in FIG. 10, the optimum current setting value changes in an inverse proportional manner with respect to the ON duty ratio. In this manner, by setting the optimum current setting value in the current suppression circuit 17 according to the ON duty ratio of the communication signal, it becomes possible to suppress the overshoot of the LED current, and to set the brightness of the illumination light when the illumination light is not modulated and the brightness of the illumination light when the illumination light is modulated to approximately equal brightness apparent for humans. It was found based on a simulation result that when the ON duty ratio is set to 75% (that is, the optimum current setting value is set to 320 mA), the overshoot of the LED current can be effectively suppressed, and the power loss in the current suppression circuit 17 can be reduced.

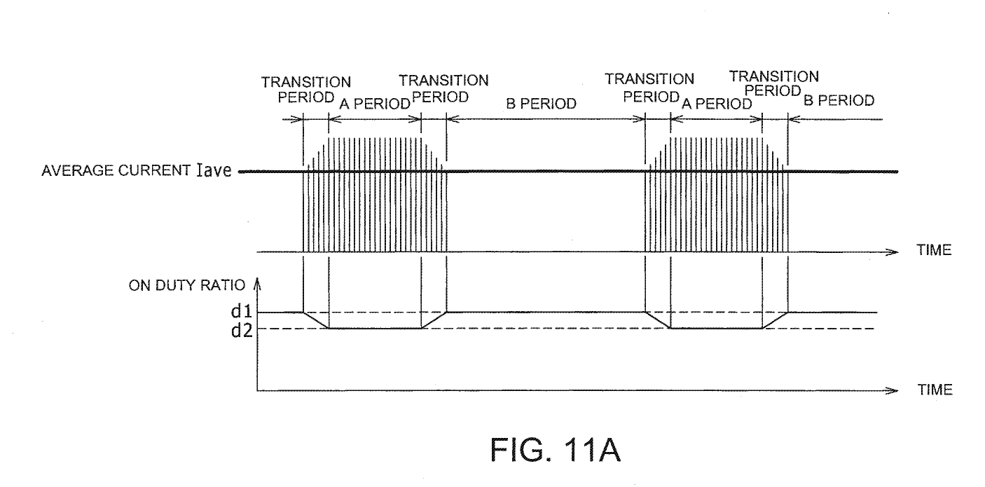

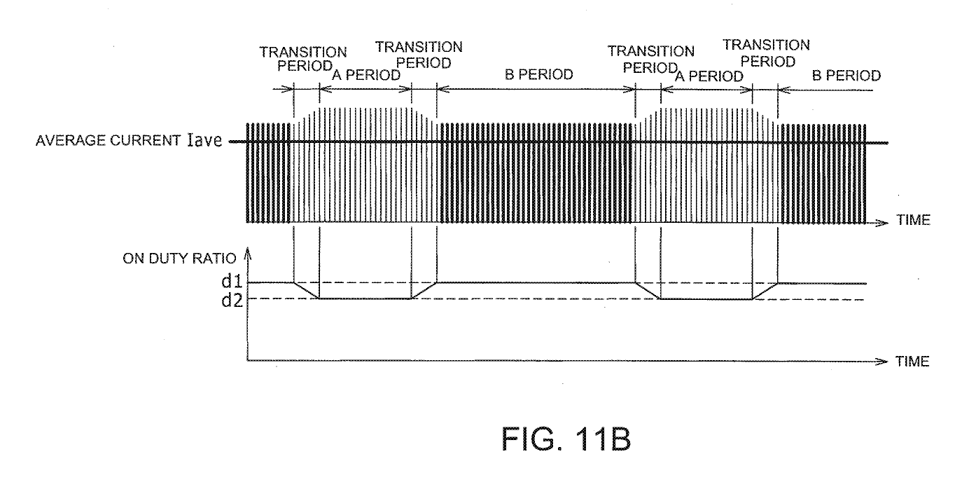

Next, with reference to FIGS. 11A-14, control of the ON duty ratio by the controller 19 of the illumination light communication apparatus 16 of the present embodiment will be described. FIG. 11A is a diagram showing gradual change of the ON duty ratio in a transition period which is set between a DC lighting mode and a modulation mode.

As shown in FIG. 11A, the transition period is set between a B period in which the light source 18 is lighted in the DC lighting mode, and an A period in which the light source 18 is lighted in the modulation mode. The transition period corresponds to a current change period in which the current flowing in the current suppression circuit 17 (that is, the light source 18) changes. Here, the DC lighting mode is a lighting mode in which the intermittent switch SW is maintained at the ON state, and the light source 18 is set to the lighted state by a DC current supplied from the constant current generation device 12. Therefore, an ON duty ratio d1 of the intermittent switch SW in the DC lighting mode is 100%.

On the other hand, the modulation mode is a lighting mode in which the intermittent switch SW is controlled to be switched ON and OFF according to the communication signal from the signal generator circuit SG, so that the illumination light from the light source 18 is modulated and the information such as the unique ID is superposed. An ON duty ratio d2 in the modulation mode is set, for example, to 75% (refer to the case (d) of FIG. 8).

An average current Iave of the current flowing in the light source 18 (hereinafter referred to as “LED current”) during the B period, which is the DC lighting mode, is constant, and is 240 mA, for example. In contrast, in the switching from the B period, which is the DC lighting mode, to the A period, which is the modulation mode, the overshoot of the LED current is suppressed by the function of the current suppression circuit 17 described above, but the ON duty ratio d2 is set smaller than the ON duty ratio d1 during the DC lighting mode. Thus, the peak value Ip of the LED current in the modulation mode can be calculated from formula (1) as follows.

Ip=Iave/d=Iave/0.75=1.33×Iave

In this manner, in the modulation mode, the peak current Ip flowing in the light source 18 is increased by a factor of 1.33 times. Specifically, when the LED current during the DC lighting mode is 240 mA, the peak current Ip during the modulation mode is approximately 319 mA. This matches the fact that, as shown in FIG. 10, the current setting value at the current suppression circuit 17 is set to 320 mA when the ON duty ratio is 75%. However, as described above, in the illumination apparatus 10 of the present embodiment, because the LED average current Iave is controlled to be a constant and approximately 240 mA, for example, the light intensity of the illumination light of the light source 18 is approximately equal to that in the DC lighting mode.

As described above, because the peak current Ip flowing in the light source 18 is increased (for example, by a factor of 1.33 times) during switching from the B period, which is the DC lighting mode, to the A period, which is the modulation mode, there may be cases where the illumination light appears to flicker to the human eye during the switching.

In order to suppress the occurrence of such flickering, in the illumination apparatus 10 of the present embodiment, the transition period is provided during the switching of the lighting state of the light source 18 between the DC lighting mode and the modulation mode, and control is applied to gradually change the ON duty ratio of the intermittent switch SW during the transition period. More specifically, when the lighting state of the light source 18 is switched from the DC lighting mode (B period) to the modulation mode (A period), the controller 19 gradually decreases the ON duty ratio of the intermittent switch SW from d1 to d2. On the other hand, when the lighting state of the light source 18 is switched from the modulation mode (A period) to the DC lighting mode (B period), the controller 19 gradually increases the ON duty ratio of the intermittent switch SW from d2 to d1. In this process, it is desirable that the controller 19 gradually decreases or gradually increases the ON duty ratio between d1 and d2 by a step of a predetermined value Δd (for example, 5%).

A temporal length of the transition period is desirably set to, for example, about 0.5 seconds to a few seconds. When the period is shorter than 0.5 seconds, the flickering suppression effect is reduced, and when the period is longer than a few seconds, a disadvantage occurs in that, for example, a long inspection time will be required during manufacture of the illumination equipment 14.

By setting the transition period and gradually changing the ON duty ratio of the intermittent switch SW as described above, it becomes possible to suppress occurrence of flickering at the switching between the DC lighting mode and the modulation mode.

In FIG. 11A, a case is exemplified in which the DC lighting mode and the modulation mode are alternately switched, but the present disclosure is not limited to such a configuration, and a configuration may be employed in which, once the mode is transitioned from the DC lighting mode to the modulation mode, the lighting state in the modulation mode is continued.

FIG. 11B is a diagram showing gradual change of the ON duty ratio in a transition period which is set between a first modulation mode and a second modulation mode. In FIG. 11B, a first modulation mode having an ON duty ratio of d2 is shown as an A period, and a second modulation mode having an ON duty ratio of d1 is shown as a B period. Here, the ON duty ratio d1 is larger than the ON duty ratio d2.

As shown in FIG. 11B, during the switching from the first modulation mode to the second modulation mode, or during the switching in the reversed manner, the transition period may be set, and the ON duty ratio may be gradually changed.

More specifically, in the switching from the first modulation mode (A period) to the second modulation mode (B period), in the transition period, the ON duty ratio is gradually increased from d2 to d1. On the other hand, in the switching from the second modulation mode (B period) to the first modulation mode (A period), in the transition period, the ON duty ratio is gradually decreased from d1 to d2. In the first modulation mode and the second modulation mode, and also in the transition period, the average current Iave flowing in the light source 19 is maintained at a constant.

When the mode is switched between the first modulation mode and the second modulation mode having different ON duty ratios while maintaining the average current Iave at a constant, the ON duty ratio may be gradually changed, to suppress occurrence of the flickering during the switching of the modulation modes.

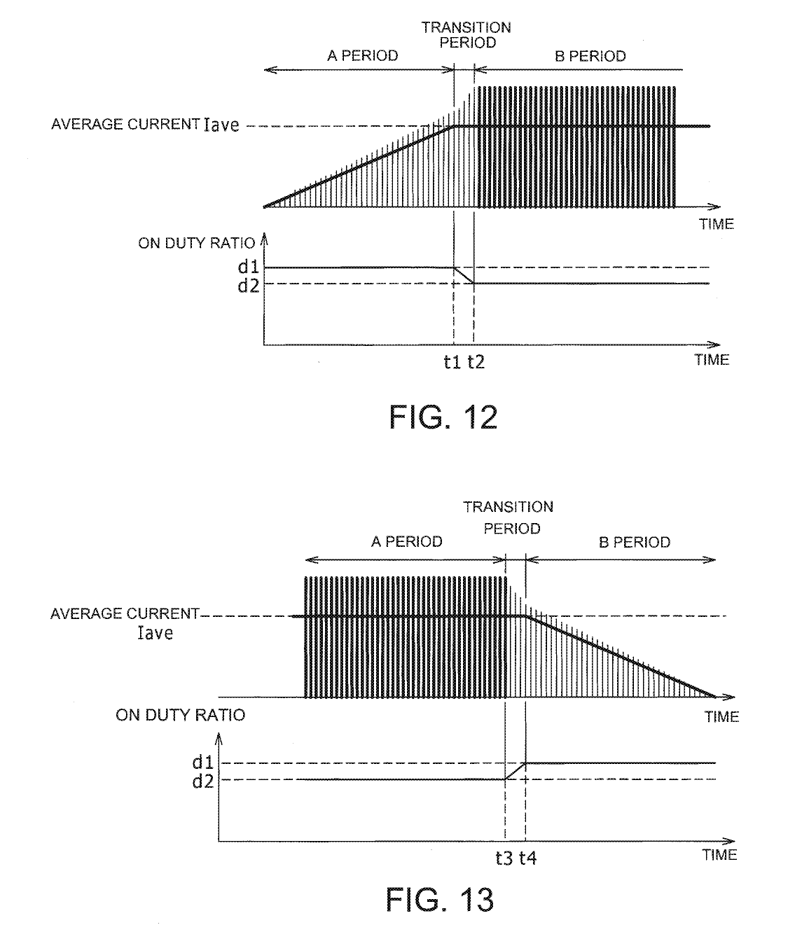

FIG. 12 is a diagram showing gradual change of the ON duty ratio in a transition period which is set at a startup of the illumination apparatus 10. In the illumination apparatus 10 of the present embodiment, the transition period is set after the constant current generation device 12 is started up and immediately before the modulation mode (B period) is started. In the transition period, the ON duty ratio of the intermittent switch SW may be gradually decreased.

More specifically, as shown in FIG. 12, when the power supply of the illumination apparatus 10 is switched ON, and the constant current generation device 12 is started up, the LED current is increased with time during an A period, and the LED current reaches the average current Iave when a time t1 has elapsed from the switching ON of the power supply. The ON duty ratio of the intermittent switch SW in the A period is set at d1 (for example, 100%). Then, a period between the time t1 and a time t2 is set as a transition period, and the ON duty ratio is gradually decreased in this period from d1 to d2 (for example, 75%). After the transition period has elapsed, the ON duty ratio is set at d2, and the lighting state of the light source 18 is set to the modulation mode (B period). Even after the mode is transitioned to the modulation mode, the LED current is maintained such that the average current of Iave is constant.

In the example configuration of FIG. 12 also, the temporal length of the transition period and the changing of the ON duty ratio may be set in a manner similar to FIG. 11A described above. In this manner, by setting the transition period after the illumination apparatus 10 is started up and immediately before the modulation mode is started, and gradually decreasing the ON duty ratio of the intermittent switch SW from d1 to d2 in the transition period, it becomes possible to suppress occurrence of the flickering at the start of the modulation mode.

In FIG. 12, an example configuration is described in which the transition period is started immediately after the LED current reaches the average current Iave, but the present disclosure is not limited to such a configuration, and the transition period may alternatively be started after waiting for the LED current to become stable at the average current Iave.

FIG. 13 is a diagram showing gradual change of the ON duty ratio in a transition period which is set at the time when driving of the illumination apparatus 10 is stopped. As shown in FIG. 13, a transition period may be set immediately after the constant current generation device 12 is stopped and the modulation mode is completed, and the controller 19 may gradually increase the ON duty ratio of the intermittent switch SW in the transition period.

More specifically, when the lighting state by the modulation mode is continued until a time t3 (A period), and a stop command of the illumination apparatus 10 (that is, the constant current generation device 12) is input at the time t3, the transition period is set between the time t3 and a time t4. In this case, the controller 19 can set the start time of the transition period (time t3) by a signal indicating that a switch or the like (not shown) is operated to be switched OFF being input wirelessly or in a wired manner. During the transition period, the ON duty ratio of the intermittent switch SW is gradually increased from d2 (for example, 75%) to d1 (for example, 100%). In the transition period, the LED current has a constant average current Iave. After the transition period has elapsed, the ON duty ratio is fixed at d1, and the LED current is reduced in this state, and is finally set to zero (that is, an extinguished state).

In the example configuration of FIG. 13 also, the temporal length of the transition period and the changing of the ON duty ratio may be set in a manner similar to that of FIG. 11A as described above. In this manner, by setting the transition period immediately after the constant current generation device 12 is stopped and the modulation mode (A period) is completed, and gradually increasing the ON duty ratio of the switch in the transition period by the controller 19, it becomes possible to suppress occurrence of the flickering at the completion of the modulation mode.

In the above description, an example configuration is described in which the transition period is started simultaneously with the input of the stopping signal of the illumination apparatus 10, but the present disclosure is not limited to such a configuration. For example, when the stop signal by the OFF operation of the switch or the like cannot be obtained by the controller 19, the LED current may be detected by a current sensor (not shown), and the transition period may be started when the LED current starts to be reduced from the average current Iave.

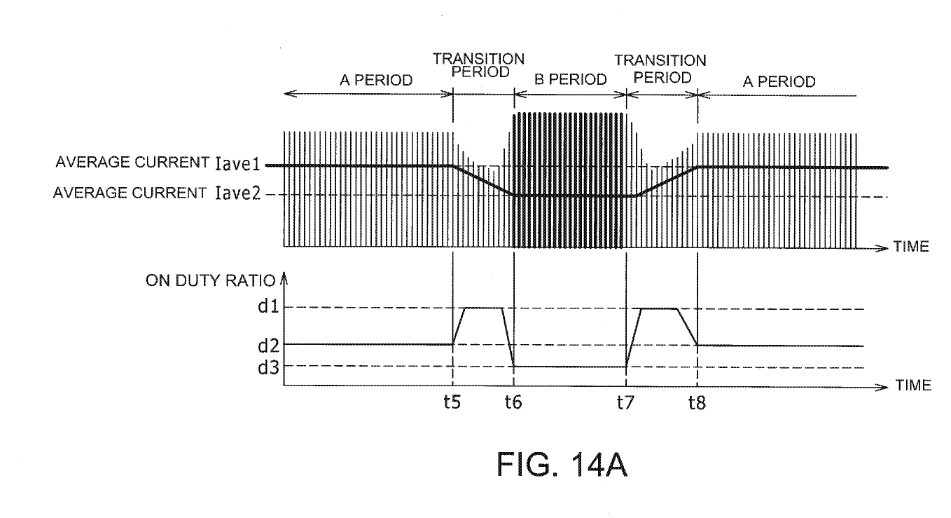

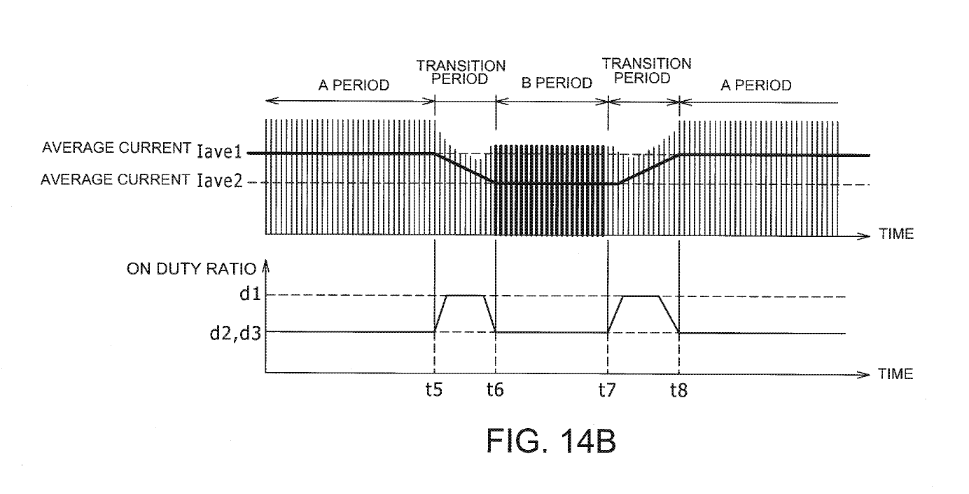

FIG. 14A is a diagram showing gradual change of the ON duty ratio in a transition period which is set between a first light adjustment state and a second light adjustment state having different light intensities of the light source. As shown in FIG. 14A, the transition period is set during the switching between a first light adjustment mode (A period) and a second light adjustment mode (B period) having different values for the average current Iave flowing in the light source 18. The controller 19 may first gradually increase the ON duty ratio of the intermittent switch SW and then gradually decrease the ON duty ratio in the transition period.

More specifically, until a time t5, the device is lighted in the first light adjustment state (A period) in the modulation mode with an LED average current of Iave1. At time t5, the constant current generation device 12 and the illumination light communication apparatus 16 receive a light adjustment signal LAS from the remote switch RS (refer to FIG. 1), and the controller 19 sets the transition period. In the transition period, the ON duty ratio of the intermittent switch SW is first gradually increased from d2 (for example, 75%) to d1 (for example, 100%), and then gradually decreased from d1 to d3 (for example, 66.7%) by the controller 19. In addition, during the transition period, the output of the constant current generation device 12 is changed so that the LED average current is gradually decreased from Iave1 to Iave2. In a period between a time t6 and a time t7, the second light adjustment state is continued in the modulation mode with the LED average current of Iave2 and the ON duty ratio of d3.

Then, at a time t7, the light adjustment signal LAS from the remote switch RS (refer to FIG. 1) is received, and the controller 19 first gradually increases the ON duty ratio from d3 to d1, and then gradually decreases from d1 to d2. At times after a time t8, the second light adjustment state is continued in the modulation mode with the LED average current of Iave1 and the ON duty ratio of d2.

In this manner, by first gradually increasing the ON duty ratio and then gradually decreasing the ON duty ratio in the transition period which is set between the first light adjustment state (A period) and the second light adjustment state (B period) having different light intensities of the light source 18, it becomes possible to suppress occurrence of the flickering when the light adjustment state is switched.

FIG. 14B is a diagram showing a case where the ON duty ratio of the modulation mode is the same between the first light adjustment state and the second light adjustment state in FIG. 14A. In FIG. 14A, a case is exemplified in which the ON duty ratio of the intermittent switch SW is different between the first light adjustment state (A period) and the second light adjustment state (B period), but the present disclosure is not limited to such a configuration. As shown in FIG. 14B, the ON duty ratio d2 of the first light adjustment state and the ON duty ratio d3 of the second light adjustment state may be the same (for example, 75%). With such a configuration also, similar operation and advantage can be achieved.

The illumination light communication apparatus, the illumination equipment, and the illumination apparatus of the present disclosure are not limited to the above-described embodiment and alternative configurations thereof, and various modifications and improvements are possible within the scope and spirit of the present disclosure.

1. An illumination light communication apparatus to be connected to a light source that emits illumination light due to a current from a constant current generation device flowing in the light source, and that modulates the illumination light of the light source, the illumination light communication apparatus comprising:
a switch that is connected in series to the light source;
a signal generator circuit that generates a binary communication signal which controls ON and OFF states of the switch to modulate the illumination light;
a current suppression circuit that is connected in series to the light source and the switch, and that suppresses the current flowing in the light source so that a current setting value corresponding to a reference value is not exceeded; and
a controller that can change an ON duty ratio of the switch through the communication signal, wherein
the controller changes the ON duty ratio of the switch during a transition period in which a current flowing in the current suppression circuit changes.

2. The illumination light communication apparatus according to claim 1, comprising a multiple-use control circuit that has functions of both the signal generator circuit and the current suppression circuit.

3. The illumination light communication apparatus according to claim 1, wherein the current suppression circuit suppresses the current flowing in the light source by controlling the switch.

4. The illumination light communication apparatus according to claim 1, wherein
the transition period is set during switching between a first modulation mode and a second modulation mode having a constant average current flowing in the light source but different ON duty ratios, and the controller changes the ON duty ratio of the switch during the transition period.

5. The illumination light communication apparatus according to claim 1, wherein
the transition period is set during switching of a lighting state of the light source from a DC lighting mode to a modulation mode, and the controller decreases the ON duty ratio of the switch during the transition period.

6. The illumination light communication apparatus according to claim 1, wherein
the transition period is set during switching of a lighting state of the light source from a modulation mode to a DC lighting mode, and the controller increases the ON duty ratio of the switch during the transition period.

7. The illumination light communication apparatus according to claim 1, wherein
the transition period is set after the constant current generation device is started up and immediately before the modulation mode is started, and the controller decreases the ON duty ratio of the switch during the transition period.

8. The illumination light communication apparatus according to claim 1, wherein
the transition period is set immediately after the constant current generation device is stopped and the modulation mode is completed, and the controller increases the ON duty ratio of the switch during the transition period.

9. The illumination light communication apparatus according to claim 1, wherein
the transition period is set during switching between a first light adjustment state and a second light adjustment state having different values for the average current flowing in the light source, and the controller first increases the ON duty ratio of the switch and then decreases the ON duty ratio during the transition period.

10. An illumination equipment comprising:
the illumination light communication apparatus according to claim 1; and
the light source.

11. An illumination apparatus comprising:
the illumination equipment according to claim 10; and
the constant current generation device.
